(19) United States
(12) Patent Application Publication
(10) Pub. No.: US 2007/0019027 A1
(43) Pub. Date: Jan. 25, 2007

(54) Aligning apparatus of inkjet head, inkjet alignment layer printing apparatus including the aligning apparatus, and method thereof

(75) Inventors: Jin-Soo Jung, Goyang-si (KR); Baek-Kyun Jeon, Yongin-si (KR); Yong-Hwan Shin, Yongin-si (KR); Jong-Sung Bae, Cheonan-si (KR); Yong-Kuk Yun, Suwon-si (KR); Duck-Jong Suh, Seoul (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/489,066

(22) Filed: Jul. 19, 2006

(30) Foreign Application Priority Data
Jul. 22, 2005 (KR) 10-2005-0066645

(51) Int. Cl. B41J 2/015

(52) U.S. Cl. 347/20

(57) ABSTRACT

An apparatus for aligning an inkjet head includes an alignment plate disposed at a side of a printing die, and a confirmation apparatus that is spaced apart from the alignment plate by a predetermined distance.

### CROSS-REFERENCE TO RELATED APPLICATION

This application claims priority to and the benefit of Korean Patent Application No. 10-2005-0066645 filed in the Korean Intellectual Property Office on Jul. 22, 2005, the entire contents of which are incorporated herein by reference.

### BACKGROUND OF THE INVENTION

(a) Field of the Invention

The present invention relates to an apparatus for aligning inkjet heads, an inkjet alignment layer printing apparatus including the aligning apparatus, and a method of aligning the inkjet heads using the aligning apparatus and the inkjet alignment layer printing apparatus.

(b) Description of Related Art

Liquid crystal displays are one of the most widely used flat panel displays. A liquid crystal display includes two display panels, each having field generating electrodes and an alignment layer, and a liquid crystal layer interposed between the display panels. The alignment layers serve to determine an initial alignment of liquid crystal molecules of the liquid crystal layer. The field generating electrode generates an electric field to change the alignment of the liquid crystal molecules. Incident light that passes through the liquid crystal layer has its polarization changed according to the alignment of the liquid crystal molecules. If polarizers of the liquid crystal display are aligned with the polarization of the incident light, a desired image can be displayed by changing the transmittance of incident light.

An active matrix liquid crystal display includes a plurality of pixel electrodes and a common electrode for generating the electric field, a plurality of switching elements such as thin film transistors (TFTs) for selectively interrupting a data voltage applied to the pixel electrodes, a plurality of signal lines for transferring the data voltage and a control signal to control the thin film transistor, a plurality of color filters for displaying colors, and a sealant for adhering two display panels together and sealing liquid crystal therein.

The display panels of the liquid crystal display are formed through several deposition, photolithography, and etching processes, and are covered with an alignment layer.

The alignment layer may be formed by a spin coating method or a flexo printing method. An alignment layer printing apparatus includes several metal rolls, such as an anilox roll and a printing roll which are generally engaged with each other, and a rubber plate attached thereon. In the flexo printing method, as the size of the display panel for the liquid crystal display and a substrate thereof is increased, the size and weight of the roll and the rubber plate are increased, thereby making it difficult to fabricate the alignment layer printing apparatus.

### SUMMARY OF THE INVENTION

An apparatus for aligning an inkjet head according to an exemplary embodiment of the present invention may include an alignment plate disposed at a side of a printing die, and a confirmation apparatus spaced apart from the alignment plate by a predetermined distance.

Furthermore, a plurality of holes may be formed in the alignment plate and a plurality of nozzle holes through which an alignment agent is sprayed may be formed in the inkjet head.

Furthermore, the holes may be formed at locations corresponding to an aligned position of the nozzle holes of the inkjet head.

Furthermore, the number of holes may be the same as that of the nozzle holes. A diameter of each hole may be larger than that of each nozzle hole. The diameter of the hole may be in the range of about 70 to 300 μm, and a thickness of the alignment plate may be within a range of about 0.5 to 2 mm.

Furthermore, the alignment plate may be attached to the side of the printing die. The confirmation apparatus may be a confirmation paper disposed under the alignment plate, or it may be a confirmation camera disposed under the alignment plate.

The confirmation camera may confirm an alignment agent that has been deposited through the holes.

The alignment plate may be made of a transparent material. The confirmation apparatus may be a confirmation camera disposed to point vertically downward to the alignment plate. The confirmation camera may confirm a location of the alignment agent deposited on the alignment plate. Locations of the alignment agent corresponding to any one inkjet head may be set as reference locations, and locations of the alignment agent corresponding to other inkjet heads are confirmed on the basis of the reference locations to align the other inkjet heads.

Furthermore, the alignment plate may have a plurality of hole patterns indicated on its surface. The hole patterns may be indicated at locations corresponding to an aligned position of nozzle holes of the inkjet head. The surface of the alignment plate may have been coated with a non-stick coating.

Furthermore, whether the hole patterns coincide with deposit locations of an alignment agent deposited on a surface of the alignment plate may be determined using a confirmation camera.

A method of aligning an inkjet head according to an exemplary embodiment of the present invention may include positioning the inkjet head at an alignment plate attached to a side of a printing die, spraying an alignment agent from the inkjet head to the alignment plate, determining whether the alignment agent has passed through a plurality of holes formed in the alignment plate, and adjusting a location of an inkjet head that has sprayed an alignment agent that has not passed through the hole.

Whether the alignment agent has passed through the hole may be determined depending on whether the alignment agent has been deposited on a confirmation paper located under the alignment plate, or whether the alignment agent has passed through the hole may be determined using a confirmation camera located under the alignment plate.

A method of aligning an inkjet head according to another exemplary embodiment of the present invention may include positioning the inkjet head at an alignment plate attached to a side of a printing die, spraying an alignment agent from the inkjet head to the alignment plate, confirming a deposit location on the alignment agent using a confirmation camera, and adjusting a location of the inkjet head based on the deposit location on the alignment agent.

Furthermore, the alignment plate may be made of a transparent material. The confirmation camera may confirm the deposit location on the alignment agent from an upper side of the alignment plate.

Locations of the alignment agent corresponding to any one inkjet head may be set as reference locations, and locations of the alignment agent corresponding to other inkjet heads may be confirmed on the basis of the reference locations to align the other inkjet heads.

A method of aligning an inkjet head according to another exemplary embodiment of the present invention may include positioning the inkjet head at an alignment plate attached to a side of a printing die, spraying an alignment agent from the inkjet head to the alignment plate, determining whether the alignment agent has been deposited at hole patterns on the alignment plate using a confirmation camera, and adjusting a location of inkjet heads that have not sprayed the alignment agent at the hole patterns on the alignment plate.

The hole patterns may be indicated on a surface of the alignment plate. Furthermore, the hole patterns may be indicated on a surface of the alignment plate at locations corresponding to an aligned position of nozzle holes of the inkjet head.

An inkjet alignment layer printing apparatus according to an exemplary embodiment of the present invention may include a plurality of inkjet heads for forming an alignment layer by spraying an alignment agent on a substrate, a printing die on which the substrate is mounted, an alignment plate disposed at a side of the printing die, and a confirmation apparatus spaced apart from the alignment plate by a predetermined distance.

### BRIEF DESCRIPTION OF THE DRAWINGS

FIG. 1 is a schematic perspective view of an apparatus for aligning inkjet heads and an inkjet alignment layer printing apparatus according to an exemplary embodiment of the present invention.

FIG. 2 is a view illustrating the inkjet heads and a plurality of nozzle holes of the inkjet alignment layer printing apparatus shown in FIG. 1.

FIG. 3A is a top plan view of an alignment plate of the inkjet alignment layer printing apparatus shown in FIG. 1.

FIG. 3B is a cross-sectional view of the alignment plate taken along the line IIIb-IIIb of FIG. 3A.

FIGS. 4 and 5 are a plan view and a lateral view, respectively, of a state where the inkjet heads are disposed over the alignment plate depending on a method of aligning the inkjet heads according to an exemplary embodiment of the present invention.

FIGS. 6 and 7 are a lateral view and a perspective view, respectively, of a state where the inkjet head sprays an alignment agent so that the alignment agent passes through the hole depending on the method of aligning the inkjet head in accordance with an exemplary embodiment of the present invention.

FIG. 8 is a lateral view of an inkjet alignment layer printing apparatus according to another exemplary embodiment of the present invention.

FIG. 9 is a lateral view of an inkjet alignment layer printing apparatus according to another exemplary embodiment of the present invention.

FIG. 10 is a view illustrating an alignment plate of FIG. 9 and the alignment agent that has been deposited on the alignment plate.

FIG. 11 is a lateral view of an inkjet alignment layer printing apparatus according to another exemplary embodiment of the present invention

FIG. 12 is a view illustrating an alignment plate of FIG. 11 and the alignment agent deposited on the alignment plate.

### DETAILED DESCRIPTION OF PREFERRED EMBODIMENTS

With reference to the accompanying drawings, embodiments of the present invention will be described in order for those skilled in the art to be able to implement the invention. As those skilled in the art would realize, described embodiments may be modified without departing from the spirit or scope of the present invention.

Hereinafter, an apparatus for aligning inkjet heads, an inkjet alignment layer printing apparatus including the aligning apparatus, and a method of aligning the inkjet heads using the aligning apparatus according to exemplary embodiments of the present invention will be described in detail with reference to the accompanying drawings.

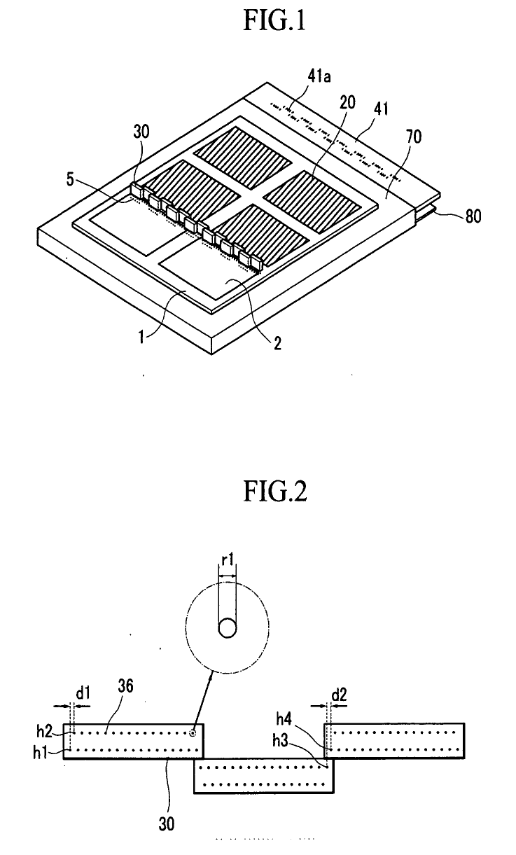

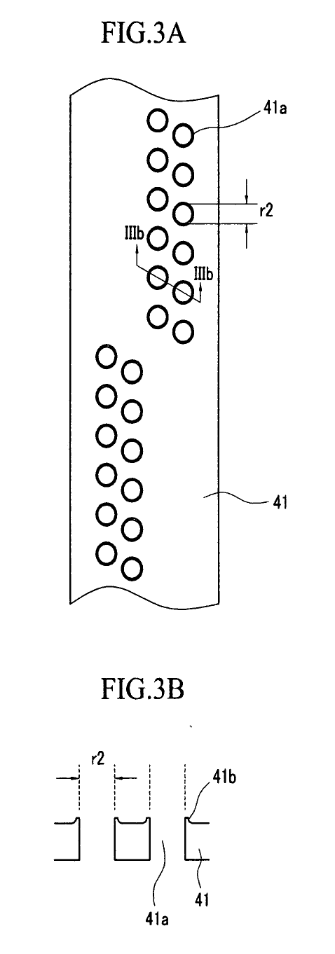

FIG. 1 is a schematic perspective view of an apparatus for aligning inkjet heads and an inkjet alignment layer printing apparatus according to an exemplary embodiment of the present invention. FIG. 2 is a view illustrating the inkjet heads and a plurality of nozzle holes of the inkjet alignment layer printing apparatus shown in FIG. 1. FIG. 3A is a top plan view of an alignment plate of the inkjet alignment layer printing apparatus shown in FIG. 1. FIG. 3B is a cross-sectional view of the alignment plate taken along the line IIIb-IIIb of FIG. 3A.

As shown in FIGS. 1 to 3B, the inkjet alignment layer printing apparatus according to an exemplary embodiment of the present invention includes a plurality of inkjet heads 30, a printing die 70, and aligning apparatuses 41 and 80 of the inkjet heads 30 for aligning the location of the inkjet heads 30. The plurality of inkjet heads 30 form alignment layers 20 by spraying an alignment agent 5 onto a substrate 1. The substrate 1 is mounted on the printing die 70.

The inkjet heads 30 partially overlap each other. A plurality of nozzle holes 36 having a predetermined diameter (r1) are formed at the bottom of each of the inkjet heads 30. The plurality of the inkjet heads 30 may form the alignment layers 20 on the substrate 1 in various patterns. The substrate 1 may have various sizes. The inkjet heads 30 partially overlap each other so that the distances (d1, d2) between the nozzle holes 36 of the same nozzle (e.g., h3 and h4) and adjacent nozzles (e.g., h1, h2) are substantially constant.

A piezoelectric actuator (not shown) is disposed at a location corresponding to the nozzle- holes 36 of the inkjet heads 30. The alignment agent 5 is sprayed as the piezoelectric actuator vibrates. The piezoelectric actuator pushes the alignment agent 5 that fills the nozzles while moving downwardly, so that the alignment agent 5 is 15 sprayed through the nozzle holes 36. When the piezoelectric actuator moves upwardly, the alignment agent 5 is supplied to the nozzles. As these processes are repeated, the inkjet heads 30 sprays a predetermined amount of the alignment agent 5 during a predetermined time. Further, as the inkjet heads 30 and the printing die 70 are moved relative to each other, the alignment layers 20 are formed for different panels 2 formed on the substrate 1.

The printing die 70 may include a vacuum chuck that supports the substrate 1 and fixes the substrate 1 to the printing die 70.

The aligning apparatuses 41 and 80 of the inkjet heads 30 include an alignment plate 41 installed at any side of the printing die 70, and a confirmation apparatus 80 that is spaced apart from the alignment plate 41 by a predetermined distance.

The alignment plate 41 is attached to the side of the printing die 70, and a plurality of holes 41a are formed therein. The holes 41a may be formed at locations corresponding to reference locations of the nozzle holes 36 of the inkjet heads 30. The reference locations may correspond to the locations of the nozzle holes 36 when the inkjet heads 30 are substantially aligned, e.g., according to a device specification.

The number of the holes 41a is the same as that of the nozzle holes 36. A diameter (r2) of each of the holes 41a may be greater than a diameter (r1) of each of the nozzle holes 36. This allows the alignment agent 5 that has been sprayed through the nozzle holes 36 to pass through the holes 41a. Each of the nozzle holes 36 may have a diameter of about 70 μm. Each of the holes 41a may have a diameter of about 70 to 300 μm, which is equal to or greater than that of the nozzle holes 36. A circumference 41b of each hole 41a is raised higher than other portions of the alignment plate 41. The raised circumference 41b substantially prevents the alignment agent 5 that has been deposited on the alignment plate 41 from clogging the entrance of the holes 41a.

The alignment plate 41 may have a thickness of about 0.5 to 2 mm. The thickness of the alignment plate 41 may be selected in consideration of a rigidity of the alignment plate 41 and a surface tension of the alignment agent 5 at the side of the holes 41a.

The confirmation apparatus 80 is a confirmation paper 80, which is spaced apart from the alignment plate 41 and is disposed under the alignment plate 41. The alignment agent 5 that has passed through the holes 41a of the alignment plate 41 is deposited on the confirmation paper 80.

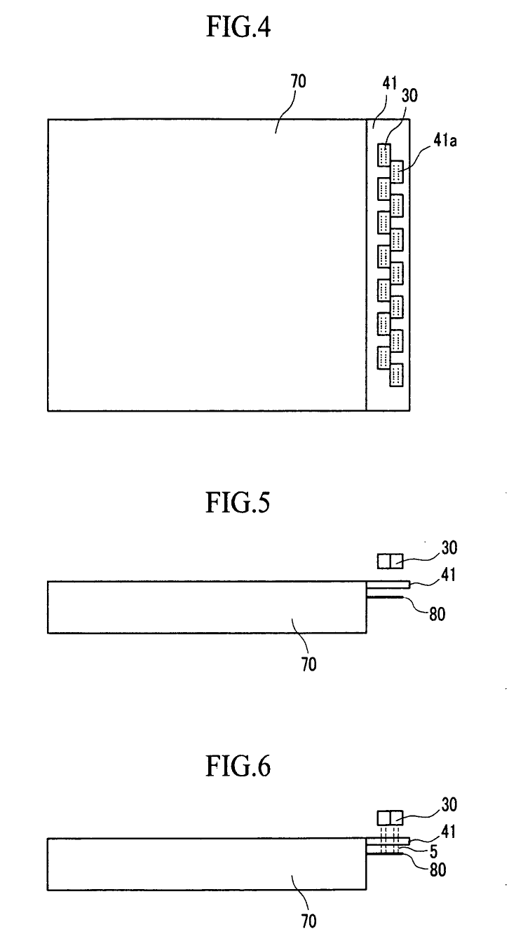

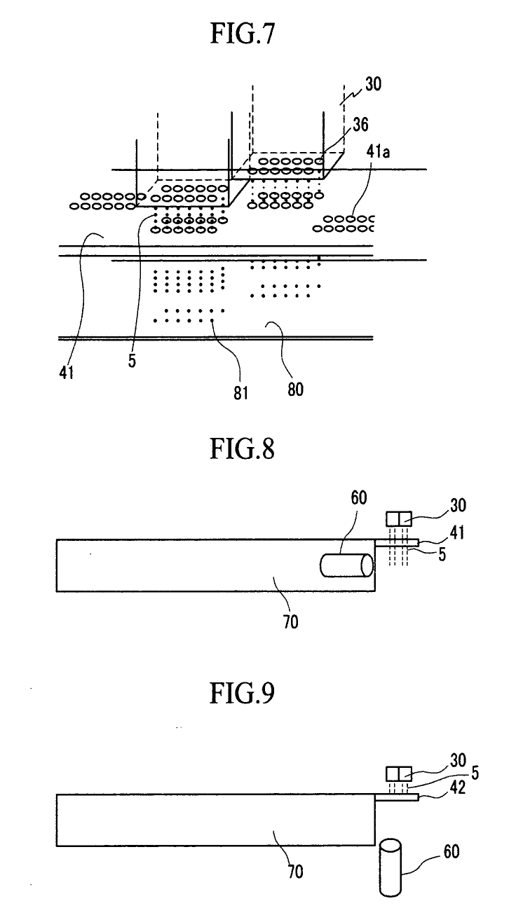

FIGS. 4 and 5 are a plan view and a lateral view, respectively, of a state where the inkjet heads are disposed over the alignment plate depending on a method of aligning the inkjet heads according to an exemplary embodiment of the present invention. FIGS. 6 and 7 are a lateral view and a perspective view, respectively, of a state where the inkjet head sprays an alignment agent so that the alignment agent passes through the hole depending on the method of aligning the inkjet head in accordance with an exemplary embodiment of the present invention.

As shown in FIGS. 4 and 5, the inkjet head 30 or the printing die 70 is moved so that the inkjet head 30 is disposed over the alignment plate 41. The location of the inkjet head 30 is controlled so that the locations of the nozzle holes of the inkjet head 30 correspond to those of the holes 41a of the alignment plate 41. The inkjet head 30 and the alignment plate 41 are spaced apart from each other by a predetermined distance (l). The predetermined distance (l) may be smaller than about 1 mm. The distance (l) between the inkjet head 30 and the alignment plate 41 may be set in consideration of factors such as the spray of the alignment agent 5, gas or resistance of foreign particles.

As shown in FIGS. 6 and 7, the alignment agent 5 is sprayed through the nozzle holes 36 of the inkjet head 30. Any alignment agent 5 that has not passed through the holes 41a of the alignment plate 41 is not deposited on the confirmation paper 80 and thus does not form a deposit point 81.

An inkjet head 30 is determined to be misaligned if the inkjet head 30 has sprayed the alignment agent 5, and the alignment agent 5 has not passed through the holes 41a. The location of the inkjet head 30 is adjusted upon determining a misalignment. The location of the inkjet head 30 can be aligned by adjusting the location of the inkjet head 30 in steps of about 10 μm in a horizontal direction or vertical direction by automatically or manually turning a screw of a micrometer attached to the inkjet head 30.

If the alignment agent 5 sprayed from the entire inkjet head 30 is formed on the confirmation paper 80 as the deposit points 81 by repeatedly performing the spraying of the alignment agent 5, the inkjet heads 30 are aligned, as may be confirmed using the confirmation paper 80.

FIG. 8 is a lateral view of an inkjet alignment layer printing apparatus according to another exemplary embodiment of the present invention. The same reference numerals in the above-mentioned drawings indicate the same components having the same functions.

As shown in FIG. 8, the inkjet alignment layer printing apparatus according to another exemplary embodiment of the present invention includes an inkjet head 30, a printing die 70, and aligning apparatuses 41 and 60 for aligning the location of the inkjet head 30.

The aligning apparatuses 41 and 60 include an alignment plate 41 disposed at any side of the printing die 70, and a confirmation apparatus 60 spaced apart from the alignment plate 41 by a predetermined distance. The confirmation apparatus 60 is a confirmation camera 60 disposed under the alignment plate 41. The confirmation camera 60 is disposed toward the printing die 70. The confirmation camera 60 may be a charge coupled device (CCD) camera or the like. The confirmation camera 60 is used to confirm that the alignment agent 5 is deposited through the holes 41a of the alignment plate 41.

As shown in FIG. 8, the inkjet heads 30 are disposed above the alignment plate 41 and the alignment agent 5 is sprayed through the nozzle holes 36 of the inkjet heads 30. Whether alignment agent 5 has passed through the holes 41a of the alignment plate 41 is confirmed using the confirmation camera 60. Accordingly, an inkjet head 30 that has sprayed the alignment agent 5, and the alignment agent 5 has not passed through the holes 41a to be confirmed using the confirmation camera 60 is determined to be misaligned. Accordingly, the location of the inkjet head 30 is adjusted.

A control unit (not shown) may control the adjustment of the inkjet heads 30. The location of the inkjet head 30 can be adjusted using positional information of the alignment agent 5, which is measured using the confirmation camera 60 by operating the control unit in cooperation with the confirmation camera 60.

FIG. 9 is a lateral view of an inkjet alignment layer printing apparatus according to another exemplary embodiment of the present invention. FIG. 10 is a view illustrating an alignment plate of FIG. 9 and the alignment agent that is deposited on the alignment plate. The same reference numerals in the above-mentioned drawings indicate the same components having the same functions.

As shown in FIG. 9, the inkjet alignment layer printing apparatus according to another exemplary embodiment of the present invention includes an inkjet head 30, a printing die 70, and aligning apparatuses 42 and 60 of the inkjet heads 30, for aligning the location of the inkjet head 30. The aligning apparatuses 42 and 60 include an alignment plate 42 disposed at any side of the printing die 70, and a confirmation apparatus 60 spaced apart from the alignment plate 42 by a predetermined distance.

The alignment plate 42 may be made of a transparent material. The confirmation apparatus 60 is a confirmation camera 60 disposed to point vertically downward from the alignment plate 42. Since the alignment plate 42 is made of a transparent material, positional information of the alignment agent 5 that is deposited on the alignment plate 42 can be confirmed using the confirmation camera 60.

As shown in FIGS. 9 and 10, the inkjet head 30 is disposed over the alignment plate 42. The alignment agent 5 is sprayed through the nozzle holes 36 of the inkjet head 30. Positional information of the alignment agent 5 deposited on the alignment plate 42 of the transparent material can be confirmed using the confirmation camera 60.

Positional information of the alignment agent 5, which is confirmed by the confirmation camera 60, is stored as data in an external unit such as a computer. Positional information of each inkjet head 30 is determined based on the positional information of the alignment agent 5. A location of alignment agent 5a, which corresponds to any one of the inkjet heads (e.g., 30, a reference inkjet head), is set to a reference location 42a (the reference location is indicated by the dotted line in FIG. 10). A reference inkjet head 30 may be the rightmost inkjet head 30, the leftmost inkjet head 30, or a middle inkjet head 30. Positional information of the remaining inkjet heads 30 may be determined based on the reference inkjet head 3. Positional information of the alignment agent 5b corresponding to the remaining inkjet heads 30 is determined based on predetermined positional information, e.g., device specifications.

If the location of the alignment agent 5b corresponding to the remaining inkjet heads 30 is disposed in line with the reference location 42a, the inkjet heads 30 are determined to be aligned. If the location of the alignment agent 5b corresponding to the remaining inkjet heads 30 is disposed differently from the reference location, the inkjet heads 30 are determined to be misaligned. Position of the misaligned inkjet heads 30 are adjusted to comply with device specifications using positions of other inkjet heads 30, which may be determined by the reference inkjet heads 30.

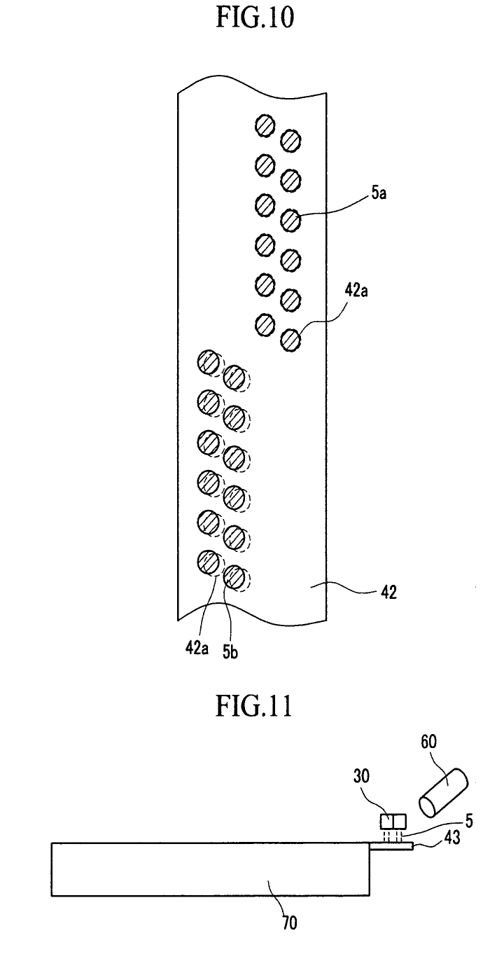

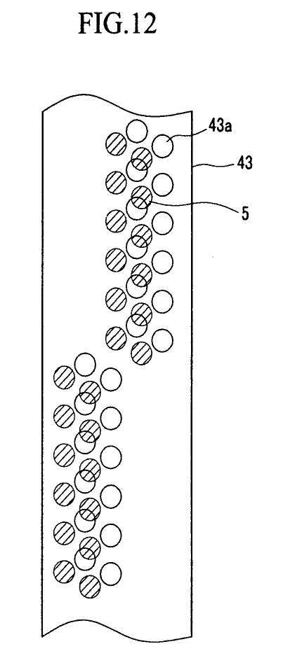

FIG. 11 is a lateral view of an inkjet alignment layer printing apparatus according to another exemplary embodiment of the present invention. FIG. 12 is a view illustrating an alignment plate of FIG. 11 and the alignment agent that is deposited on the alignment plate. The same reference numerals in the above-mentioned drawings indicate the same components having the same functions.

As shown in FIGS. 11 and 12, the inkjet alignment layer printing apparatus according to an exemplary embodiment of the present invention includes inkjet heads 30, a printing die 70, and aligning apparatuses 43 and 60 for aligning the location of the inkjet heads 30. The aligning apparatuses 43 and 60 of the inkjet heads 30 include an alignment plate 43 disposed at any side of the printing die 70, and a confirmation apparatus 60 spaced apart from the alignment plate 43 by a predetermined distance.

A plurality of hole patterns 43a is drawn on a surface of the alignment plate 43. The hole patterns 43a are drawn at locations corresponding to reference locations of nozzle holes 36 of the inkjet heads 30. The reference locations correspond to the locations of the nozzle holes 36 when the inkjet heads 30 are aligned. The surface of the alignment plate 42 has a Teflon® coating or other non-stick coating. Accordingly, the hole patterns 43a are not removed. The confirmation apparatus 60 may be a confirmation camera 60 disposed to point upwardly from the alignment plate 42. The confirmation camera 60 is used to confirm whether the hole patterns 43a coincide with the locations of the alignment agent 5 that is deposited on the surface of the alignment plate 42.

As shown in FIGS. 11 and 12, the inkjet head 30 is disposed over the alignment plate 43. The alignment agent 5 is sprayed through the nozzle holes 36 of the inkjet head 30. The hole patterns 43a on the surface of the alignment plate 43 are drawn at locations corresponding to the reference locations of the nozzle holes 36 of the inkjet head 30. Whether the alignment agent 5 has been deposited on the hole patterns 43a of the alignment plate 43 is determined using the confirmation camera 60. If it is determined that the alignment agent 5 is deposited in line with the hole patterns 43a, it is considered that the inkjet head 30 that has sprayed the alignment agent 5 is aligned. If it is determined that the alignment agent 5 is deposited at places other than the hole patterns 43a, it is considered that the inkjet head 30 that has sprayed the alignment agent 5 is misaligned. The location of the misaligned inkjet head 30 is adjusted until a position is achieved in line with the hole patterns 43a.

In accordance with an apparatus for aligning inkjet heads, an inkjet alignment layer printing apparatus including the aligning apparatus, and a method of aligning the inkjet heads using the aligning apparatus and the inkjet alignment layer printing apparatus, positional information of an alignment agent sprayed from the inkjet head is obtained using an alignment plate and a confirmation apparatus, and inkjet heads are aligned based on the positional information.

While the present invention has been described in connection with exemplary embodiments, it is to be understood that the present invention is not limited to thereto, and is intended to cover various modifications and equivalent arrangements included within the spirit and scope of the disclosure.

What is claimed is:

1. An apparatus for aligning an inkjet head, comprising:
an alignment plate disposed at a side of a printing die; and
a confirmation apparatus spaced apart from the alignment plate by a predetermined distance.

2. The apparatus of claim 1, wherein a plurality of holes is formed in the alignment plate.

3. The apparatus of claim 2, wherein a plurality of nozzle holes through which an alignment agent is sprayed are formed in the inkjet head.

4. The apparatus of claim 3, wherein the holes are formed at locations corresponding to an aligned position of the nozzle holes of the inkjet head.

5. The apparatus of claim 3, wherein the number of the holes is the same as that of the nozzle holes.

6. The apparatus of claim 3, wherein a diameter of each hole is larger than that of each nozzle hole.

7. The apparatus of claim 6, wherein the diameter of each hole is in the range of about 70 to 300 μm.

8. The apparatus of claim 1, wherein a thickness of the alignment plate is within a range of about 0.5 to 2 mm.

9. The apparatus of claim 1, wherein the alignment plate is attached to the side of the printing die.

10. The apparatus of claim 2, wherein the confirmation apparatus is a confirmation paper disposed under the alignment plate.

11. The apparatus of claim 2, wherein the confirmation apparatus is a confirmation camera disposed under the alignment plate.

12. The apparatus of claim 11, wherein the confirmation camera confirms that an alignment agent has been deposited through the holes.

13. The apparatus of claim 1, wherein the alignment plate is made of a transparent material.

14. The apparatus of claim 13, wherein the confirmation apparatus is a confirmation camera disposed to point vertically downward to the alignment plate.

15. The apparatus of claim 14, wherein the confirmation camera confirms a location of the alignment agent deposited on the alignment plate.

16. The apparatus of claim 15, wherein locations of the alignment agent corresponding to any one inkjet head are set as a reference location and locations of alignment agent corresponding to other inkjet heads are confirmed on the basis of the reference location to align the other inkjet heads.

17. The apparatus of claim 1, wherein the alignment plate has a plurality of hole patterns indicated on its surface.

18. The apparatus of claim 17, wherein the hole patterns are indicated at locations corresponding to an aligned position of nozzle holes of the inkjet head.

19. The apparatus of claim 18, wherein the surface of the alignment plate is coated with a non-stick coating.

20. The apparatus of claim 17, wherein whether the hole patterns coincide with deposit locations of an alignment agent deposited on a surface of the alignment plate is determined using a confirmation camera.

21. A method of aligning an inkjet head, comprising:
positioning the inkjet head at an alignment plate attached to a side of a printing die;
spraying an alignment agent from the inkjet head to the alignment plate;
determining whether the alignment agent has passed through a plurality of holes formed in the alignment plate; and
adjusting a location of an inkjet head that has sprayed an alignment agent that has not passed through a hole.

22. The method of claim 21, wherein whether the alignment agent has passed through the hole is determined depending on whether the alignment agent has been deposited on a confirmation paper located under the alignment plate.

23. The method of claim 21, wherein whether the alignment agent has passed through the hole is determined using a confirmation camera located under the alignment plate.

24. A method of aligning an inkjet head, comprising:
positioning the inkjet head at an alignment plate attached to a side of a printing die;
spraying an alignment agent from the inkjet head to the alignment plate;
confirming a deposit location on the alignment agent using a confirmation camera; and
adjusting a location of the inkjet head based on the deposit location on the alignment agent.

25. The method of claim 24, wherein the alignment plate is made of a transparent material.

26. The method of claim 24, wherein the confirmation camera confirms the deposit location on the alignment agent from an upper side of the alignment plate.

27. The method of claim 26, wherein locations of the alignment agent corresponding to any one inkjet head are set as a reference location and locations of the alignment agent corresponding to other inkjet heads are confirmed on the basis of the reference location to align the other inkjet heads.

28. A method of aligning an inkjet head, the method comprising:
positioning the inkjet head at an alignment plate attached to a side of a printing die;
spraying an alignment agent from the inkjet head to the alignment plate;
determining whether the alignment agent has been deposited at hole patterns on the alignment plate using a confirmation camera; and
adjusting a location of inkjet heads that have not sprayed the alignment agent at the hole patterns on the alignment plate.

29. The method of claim 28, wherein the hole patterns are indicated on a surface of the alignment plate.

30. The method of claim 29, wherein the hole patterns are indicated at locations corresponding to an aligned position of nozzle holes of the inkjet head.

31. An inkjet alignment layer printing apparatus, comprising:
a plurality of inkjet heads for forming an alignment layer by spraying an alignment agent on a substrate;
a printing die on which the substrate is mounted;
an alignment plate disposed at a side of the printing die; and
a confirmation apparatus that is spaced apart from the alignment plate by a predetermined distance.
